(19) United States
(12) Patent Application Publication
(10) Pub. No.: US 2026/0153197 A1
(43) Pub. Date: Jun. 4, 2026

(54) WORK VEHICLE MANAGEMENT DEVICE, SYSTEM, AND WORK VEHICLE MANAGEMENT METHOD

(71) Applicant: Komatsu Ltd., Tokyo (JP)

(72) Inventor: Hideyo EBISUZAKI, Tokyo (JP)

(21) Appl. No.: 18/704,548

(22) PCT Filed: Nov. 9, 2022
(86) PCT No.: PCT/JP2022/041758

§ 371 Date: Apr. 25, 2024

(30) Foreign Application Priority Data
Nov. 9, 2021 (JP) 2021-182421

(51) Int. Cl. F17C 13/02; F17C 5/06

(52) U.S. Cl. CPC F17C 13/025; F17C 5/06; F17C 2221/012; F17C 2250/034; F17C 2250/0434; F17C 2260/025; F17C 2265/065; F17C 2270/0171

(57) ABSTRACT

A measured value acquisition unit acquires a measured value of a pressure of a hydrogen tank of each of a plurality of work vehicles, on which the hydrogen tanks are mounted, and a measured value of a pressure of a pressure accumulator of a hydrogen station where the hydrogen tanks are filled with a hydrogen gas. An estimation unit estimates a value related to a filling time of the hydrogen gas at the hydrogen station for the plurality of work vehicles based on the measured values of the pressures. The determination unit determines filling timings of the hydrogen gas for the plurality of work vehicles such that the total of the filling times is minimized based on the value related to the filling time.

### TECHNICAL FIELD

The present disclosure relates to a work vehicle management device, a system, and a work vehicle management method.

Priority is claimed on Japanese Patent Application No. 2021-182421, filed Nov. 9, 2021, the content of which is incorporated herein by reference.

### BACKGROUND ART

Patent Document 1 discloses a technique of scheduling oil supply timings of a plurality of work vehicles configuring a fleet. According to Patent Document 1, the oil supply timings can be scheduled such that a waiting time is not generated due to the fact that a certain number or more of work vehicles simultaneously arrive at the same gas station.

### Citation List

### Patent Document

### Patent Document 1

Japanese Unexamined Patent Application, First Publication No. 2004-185358

### SUMMARY OF INVENTION

### Technical Problem

A work vehicle on which a fuel cell using a hydrogen gas as a fuel is mounted has been studied. A hydrogen tank filled with the hydrogen gas, which is the fuel, is mounted on such a work vehicle. The filling of the hydrogen gas is performed by connecting a pressure accumulator that is provided at a hydrogen station and that stores the hydrogen gas at a high pressure and the hydrogen tank to each other. The hydrogen tank is filled with the hydrogen gas from the pressure accumulator due to a differential pressure between the hydrogen tank and the pressure accumulator. For this reason, as the differential pressure between the hydrogen tank and the pressure accumulator increases, a speed at which the hydrogen tank is filled with the hydrogen gas increases. For this reason, even when the method described in Patent Document 1 is applied to the work vehicle on which the fuel cell is mounted, there is a possibility that a replenishment timing of the hydrogen gas is not necessarily appropriate.

An object of the present disclosure is to provide a work vehicle management device, a system, and a work vehicle management method that can determine filling timings of a hydrogen gas for a plurality of work vehicles on which the hydrogen tanks are mounted.

### Solution to Problem

According to an aspect of the present disclosure, there is provided a work vehicle management device including a measured value acquisition unit configured to acquire a measured value of a pressure of a hydrogen tank of each of a plurality of work vehicles, on which the hydrogen tanks are mounted, and a measured value of a pressure of a pressure accumulator of a hydrogen station where the hydrogen tanks are filled with a hydrogen gas and a determination unit configured to determine filling timings of the hydrogen gas for the plurality of work vehicles based on the measured values of the pressures.

According to another aspect of the present disclosure, there is provided a work vehicle management method including a step of acquiring a measured value of a pressure of a hydrogen tank of each of a plurality of work vehicles, on which the hydrogen tanks are mounted, and a measured value of a pressure of a pressure accumulator of a hydrogen station where the hydrogen tanks are filled with a hydrogen gas and a step of determining filling timings of the hydrogen gas for the plurality of work vehicles based on the measured values of the pressures.

### Advantageous Effects of Invention

According to the aspects, the filling timings of the hydrogen gas for the plurality of work vehicles on which the hydrogen tanks are mounted can be determined.

### BRIEF DESCRIPION OF DRAWINGS

FIG. 1 is a view showing a configuration of an automatic transport system including a management device according to a first embodiment.

FIG. 2 is a schematic block diagram showing a configuration of a hydrogen station according to the first embodiment.

FIG. 3 is a perspective view schematically showing a transport vehicle according to the first embodiment.

FIG. 4 is a schematic block diagram showing configurations of a power system and a drive system included in the transport vehicle according to the first embodiment.

FIG. 5 is a schematic block diagram showing a configuration of a control system included in the transport vehicle according to the first embodiment.

FIG. 6 is a schematic block diagram showing a configuration of the management device according to the first embodiment.

FIG. 7 is a flowchart (part 1) showing a hydrogen gas filling order determining method for the management device according to the first embodiment.

FIG. 8 is a flowchart (part 2) showing the hydrogen gas filling order determining method for the management device according to the first embodiment.

FIG. 9 is a flowchart showing a transmitting method of control data of the transport vehicle by the management device according to the first embodiment.

FIG. 10 is a schematic block diagram showing a configuration of a computer according to at least one embodiment.

### DESCRIPTION OF EMBODIMENTS

### First Embodiment

### Configuration of Automatic Transport System 1

Hereinafter, embodiments will be described in detail with reference to the drawings.

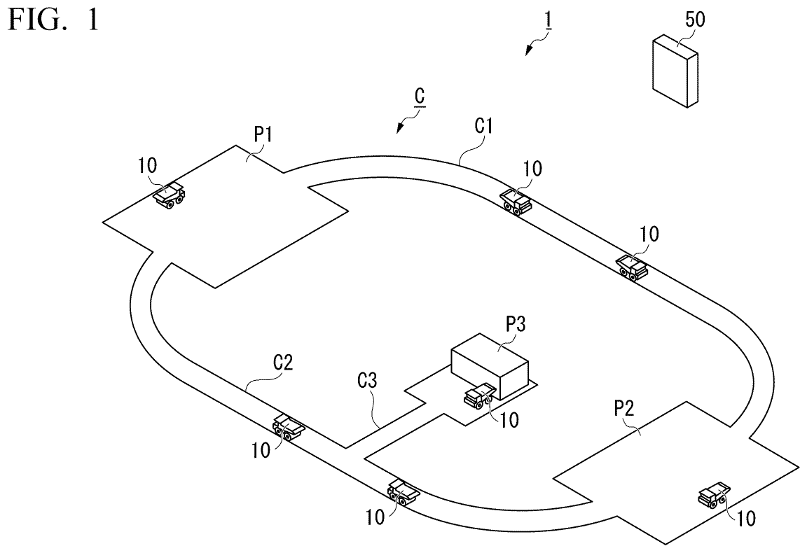

FIG. 1 is a view showing a configuration of an automatic transport system 1 including a management device 50 according to a first embodiment. The automatic transport system 1 is used in order to transport mined crushed stones or the like to a plurality of transport vehicles 10 that automatically travels in a mine. The transport vehicles 10 are driven by fuel cells fueled by a hydrogen gas. The management device 50 transmits a travel instruction to the transport vehicles 10 and controls operation of the transport vehicles 10. The transport vehicles 10 are an example of a work vehicle. The plurality of transport vehicles 10 constitute a fleet.

In the mine, a mining site P1, a dumping site P2, and a hydrogen station P3 are provided. The transport vehicle 10 transports mined stones loaded on the mining site P1 to the dumping site P2 and discharges crushed stones to the dumping site P2. When the transport vehicle 10 discharges the crushed stones to the dumping site P2, the transport vehicle 10 moves to the mining site P1 again and loads the mined stones. The transport vehicle 10 replenishes hydrogen gas at the hydrogen station P3.

A course C on which the transport vehicle 10 travels is provided in the mine. The course C includes a first passage C1, a second passage C2, and a third passage C3. The first passage C1 is a one-way passage from the mining site P1 toward the dumping site P2. The second passage C2 is a one-way passage from the dumping site P2 toward the mining site P1. The third passage C3 branches from the second passage C2 and is connected to the hydrogen station P3. In the other embodiment, the third passage C3 may branch from the first passage C1. In addition, in a case where a mine according to the other embodiment has a plurality of hydrogen stations P3, the third passage C3 is provided for each hydrogen station P3. In the example shown in FIG. 1, as the first passage C1 and the second passage C2 are provided to be separated from each other, the course C is formed in an annular shape, but the other embodiment is not limited thereto. For example, in the other embodiment, as the first passage C1 and the second passage C2 are provided to be adjacent to each other, a two-way course C may be formed.

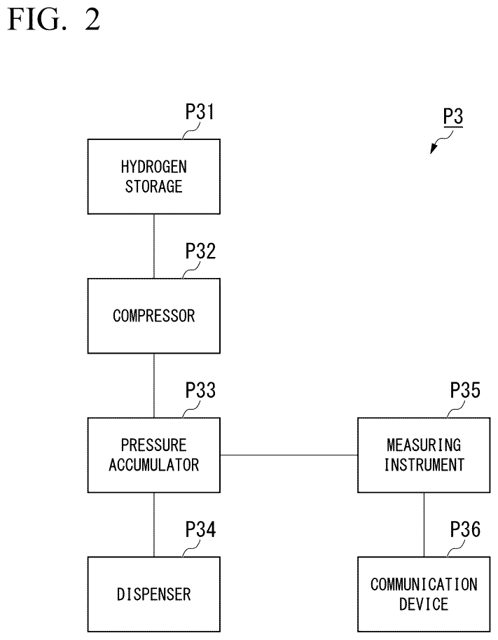

FIG. 2 is a schematic block diagram showing a configuration of the hydrogen station P3 according to the first embodiment. The hydrogen station P3 includes a hydrogen storage P31, a compressor P32, a pressure accumulator P33, a dispenser P34, a pressure gauge P35, and a communication device P36. The hydrogen storage P31 is a tank that stores a hydrogen gas. The hydrogen storage P31 stores the hydrogen gas at a 6 first pressure (for example, approximately 20 MPa). The first pressure may be lower than a pressure of a hydrogen tank 141 included in the transport vehicle 10. The pressure accumulator P33 stores a hydrogen gas at a second pressure (for example, approximately 82 MPa). The second pressure is higher than the pressure of the hydrogen tank 141 included in the transport vehicle 10. The compressor P32 raises the pressure of the hydrogen gas in the hydrogen storage P31 to the second pressure and fills the pressure accumulator P33 with the hydrogen gas. When the transport vehicle 10 is not filled with the hydrogen gas, the compressor P32 fills the pressure accumulator P33 with the hydrogen gas from the hydrogen storage P31. The dispenser P34 has a nozzle that outputs the hydrogen gas. The nozzle is configured to engage with the hydrogen tank 141. The dispenser P34 cools the hydrogen gas such that the temperature of the hydrogen tank 141 does not rise due to adiabatic compression caused by filling with the hydrogen gas. The pressure accumulator P33 and the dispenser P34 are connected to each other by a high-pressure pipe. The hydrogen station P3 according to the first embodiment can simultaneously supply the hydrogen gas to one transport vehicle 10. In the other embodiment, the hydrogen station P3 may include a plurality of pressure accumulators P33 and a plurality of dispensers P34 and be capable of supplying the hydrogen gas to the plurality of transport vehicles 10.

The pressure gauge P35 measures a pressure of the pressure accumulator P33. The communication device P36 transmits a measured value from the pressure gauge P35 to the management device 50.

### Configuration of Transport Vehicle 10

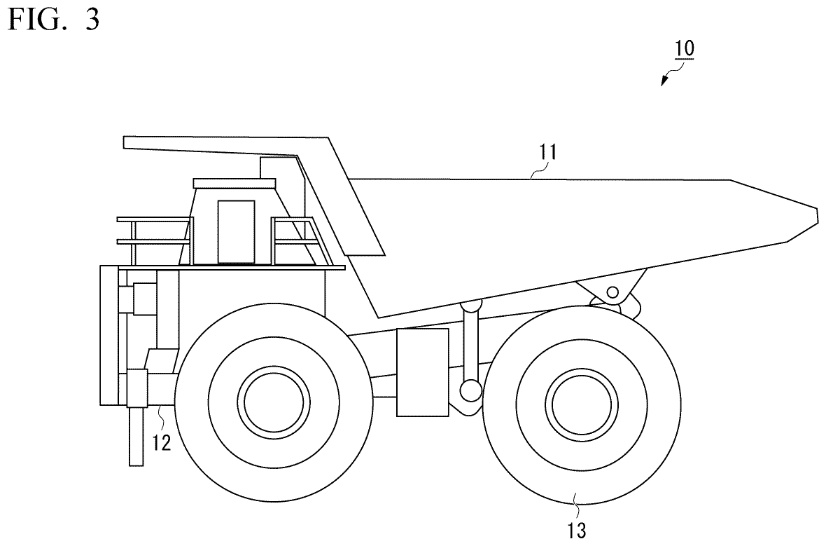

FIG. 3 is a perspective view schematically showing the transport vehicle 10 according to the first embodiment. The transport vehicle 10 includes a dump body 11, a vehicle body 12, and a traveling device 13.

The dump body 11 is a member to be loaded with a load. At least a part of the dump body 11 is disposed above the vehicle body 12. The dump body 11 performs a dumping operation and a lowering operation. Through the dumping operation and the lowering operation, the dump body 11 is adjusted to be in a dumping posture and a loading posture. The dumping posture refers to a posture in which the dump body 11 is raised. The loading posture refers to a posture in which the dump body 11 is lowered.

The dumping operation refers to an operation of separating the dump body 11 from the vehicle body 12 and inclining the dump body in a dumping direction. The dumping direction is the rear of the vehicle body 12. In the embodiment, the dumping operation includes raising a front end portion of the dump body 11 and inclining the dump body 11 rearward. Through the dumping operation, a loading surface of the dump body 11 is inclined downward toward the rear.

The lowering operation refers to an operation of bringing the dump body 11 closer to the vehicle body 12. In the embodiment, the lowering operation includes lowering of the front end portion of the dump body 11.

In a case of carrying out dumping work, the dump body 11 performs the dumping operation to change from the loading posture to the dumping posture. In a case where the dump body 11 is being loaded with a load, the load is discharged rearward from a rear end portion of the dump body 11 through the dumping operation. In a case of carrying out loading work, the dump body 11 is adjusted to be in the loading posture.

The vehicle body 12 includes a vehicle body frame. The vehicle body 12 supports the dump body 11. The vehicle body 12 is supported by the traveling device 13.

The traveling device 13 supports the vehicle body 12. The traveling device 13 causes the transport vehicle 10 to travel. The traveling device 13 causes the transport vehicle 10 to advance or retreat. At least a part of the traveling device 13 is disposed below the vehicle body 12. The traveling device 13 includes a pair of front wheels and a pair of rear wheels. The front wheels are steering wheels, and the rear wheels are driving wheels.

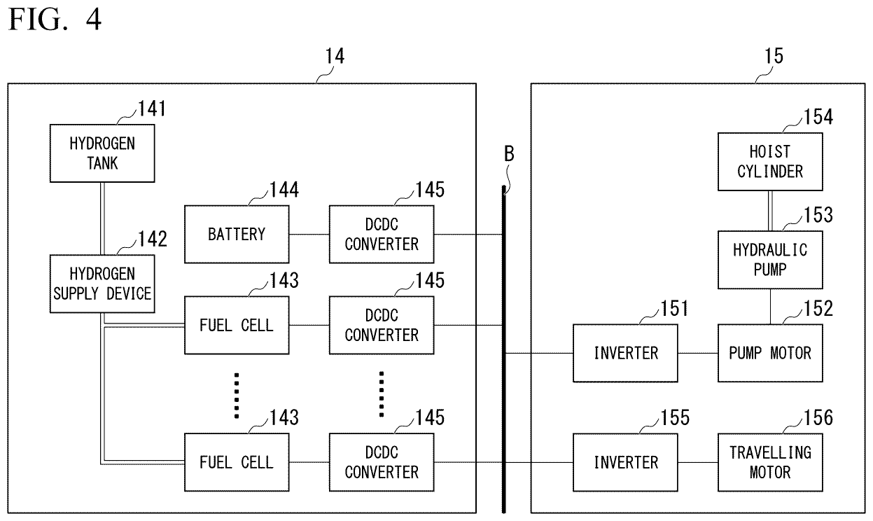

FIG. 4 is a schematic block diagram showing configurations of a power system 14 and a drive system 15 included in the transport vehicle 10 according to the first embodiment. The power system 14 includes the hydrogen tank 141, a hydrogen supply device 142, a fuel cell 143, a battery 144, and a DCDC converter 145. The power system 14 includes a plurality of fuel cells 143.

The hydrogen supply device 142 supplies a hydrogen gas filling the hydrogen tank 141 to the fuel cells 143. The fuel cells 143 generate electric power by causing an electrochemical reaction between the hydrogen supplied from the hydrogen supply device 142 and oxygen included in outside air. The battery 144 stores the electric power generated by the fuel cells 143. The DCDC converter 145 causes the electric power output from the connected fuel cells 143 or the connected battery 144 according to an instruction from a control system 16 (see FIG. 4).

Electric power output by the power system 14 is output to the drive system 15 via a bus B. The drive system 15 has an inverter 151, a pump drive motor 152, a hydraulic pump 153, a hoist cylinder 154, an inverter 155, and a travelling drive motor 156. The inverter 151 converts a direct current from the bus B into a three-phase alternating current and supplies the three-phase alternating current to the pump drive motor 152. The pump drive motor 152 drives the hydraulic pump 153. A hydraulic oil discharged from the hydraulic pump 153 is supplied to the hoist cylinder 154 via a control valve (not shown). As the hydraulic oil is supplied to the hoist cylinder 154, the hoist cylinder 154 operates. The hoist cylinder 154 causes the dump body 11 to perform the dumping operation or the lowering operation. The inverter 155 converts a direct current from the bus B into a three-phase alternating current and supplies the three-phase alternating current to the travelling drive motor 156. A rotational force generated by the travelling drive motor 156 is transmitted to the rear wheels of the traveling device 13.

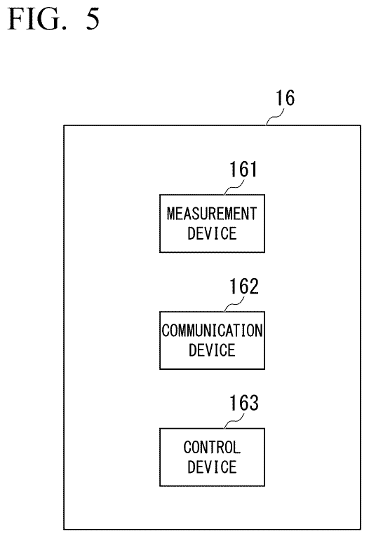

The transport vehicle 10 includes the control system 16 that controls the power system 14 and the drive system 15. FIG. 5 is a schematic block diagram showing a configuration of the control system 16 included in the transport vehicle 10 according to the first embodiment. The control system 16 includes a measurement device 161, a communication device 162, and a control device 163.

The measurement device 161 collects data related to an operating state and a traveling state of the transport vehicle 10. The measurement device 161 includes at least a positioning device that measures a position and an azimuth direction of the transport vehicle 10 with a global navigation satellite system (GNSS), a speed meter that measures the speed of the transport vehicle 10, and a pressure gauge that measures the pressure of the hydrogen tank 141.

The communication device 162 communicates with the management device 50 via a mobile communication network or the like. The communication device 162 transmits measurement data storing various types of measured values measured by the measurement device 161 to the management device 50. The communication device 162 receives control data for controlling the transport vehicle 10 from the management device 50.

The control device 163 drives the transport vehicle 10 according to control data received by the communication device 162 from the management device 50. The control device 163 generates a control signal for controlling the transport vehicle 10, for example, through PID control based on control data and a measured value from the measurement device 161. For example, the control device 163 generates a control signal for controlling steering, accelerating, braking, a dump body operation, and the like of the traveling device 13.

The control device 163 includes a processor, a memory, an auxiliary storage device, and the like connected to each other by a bus and functions as a device that generates a control signal through PID control by executing a program. Examples of the processor include a central processing unit (CPU), a graphic processing unit (GPU), and a microprocessor.

The program may be recorded on a computer-readable recording medium. The computer-readable recording medium is, for example, a storage device such as a magnetic disk, a magneto-optical disk, an optical disk, and a semiconductor memory. The program may be transmitted via a telecommunication line.

All or some of the functions of the control device 163 may be realized by using a custom large scale integrated circuit (LSI) such as an application specific integrated circuit (ASIC) and a programmable logic device (PLD). Examples of the PLD include a programmable array logic (PAL), a generic array logic (GAL), a complex programmable logic device (CPLD), and a field programmable gate array (FPGA). Such an integrated circuit is also included as an example of the processor.

### Configuration of Management Device 50

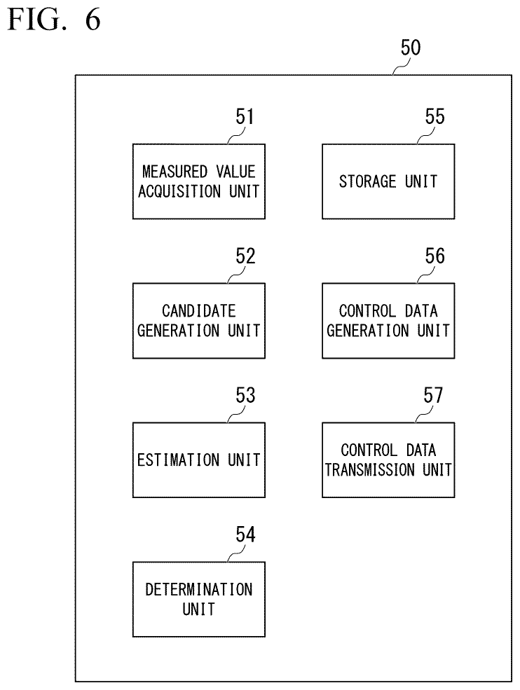

FIG. 6 is a schematic block diagram showing a configuration of the management device 50 according to the first embodiment.

The management device 50 includes a measured value acquisition unit 51, a candidate generation unit 52, an estimation unit 53, a determination unit 54, a storage unit 55, a control data generation unit 56, and a control data transmission unit 57.

The measured value acquisition unit 51 receives measured values of a position, an azimuth direction, a speed, and a pressure of the hydrogen tank 141 from the plurality of transport vehicles 10. In addition, the measured value acquisition unit 51 receives a measured value of a pressure of the pressure accumulator P33 from the hydrogen station P3.

The candidate generation unit 52 randomly determines a hydrogen gas filling order candidate of the plurality of transport vehicles 10. The filling order candidate generated by the candidate generation unit 52 is a non-overlapping sequence generated by rearranging the plurality of transport vehicles 10. The candidate generation unit 52 generates a predetermined number of filling order candidates.

The estimation unit 53 estimates a value related to a filling time in a case where filling of a hydrogen gas is performed according to a filling order candidate generated by the candidate generation unit 52. The filling time is determined by a differential pressure between the hydrogen tank 141 and the pressure accumulator P33 at a time of hydrogen gas filling start. Therefore, the estimation unit 53 according to the first embodiment calculates a total of differential pressures between the hydrogen tank 141 and the pressure accumulator P33 at the time of hydrogen gas filling start in the plurality of transport vehicles 10 as a value related to the filling time. Specifically, the estimation unit 53 simulates filling of the plurality of transport vehicles 10 with the hydrogen gas according to the filling order candidate generated by the candidate generation unit 52 based on a measured value received by the measured value acquisition unit 51 and calculates a differential pressure between the hydrogen tank 141 and the pressure accumulator P33 based on the results of the simulation.

The determination unit 54 determines a candidate having the shortest hydrogen gas filling time, among a plurality of filling order candidates generated by the candidate generation unit 52, as filling order.

The storage unit 55 stores the filling order determined by the determination unit 54.

The control data generation unit 56 generates control data of the plurality of transport vehicles 10 based on the filling order determined by the determination unit 54, data acquired by the measured value acquisition unit 51, and operation rules of the transport vehicles 10 determined in advance. The operation rules of the transport vehicles 10 are determined by a traveling direction on the course C, a traveling speed, and a standard work time on the mining site P1 and the dumping site P2. For example, the operation rules may be operation rules in which the course C may be divided into a plurality of sections, and the traveling direction and traveling speed are associated with each other for each section. The operation rules may be manually set by a manager or the like or may be automatically generated in accordance with traveling of the transport vehicle 10 on the course C.

The control data transmission unit 57 transmits the control data generated by the control data generation unit 56 to each transport vehicle 10.

### Processing of Management Device 50

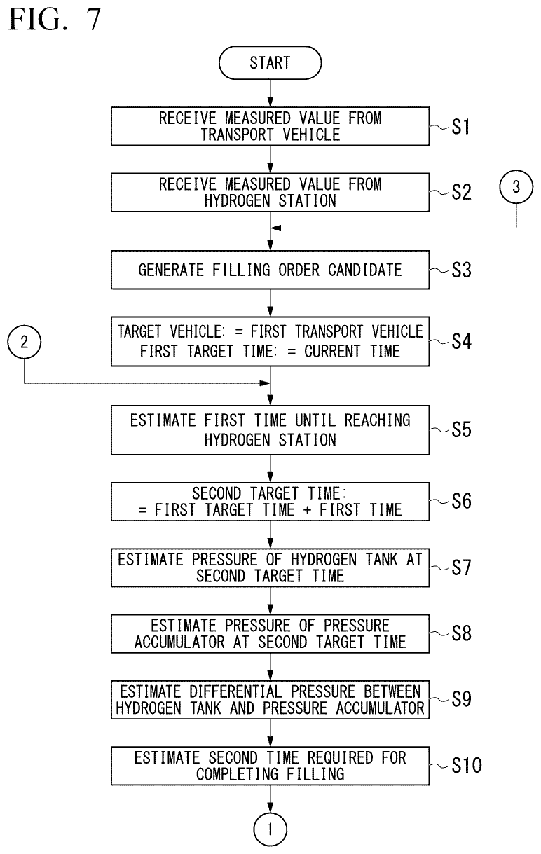

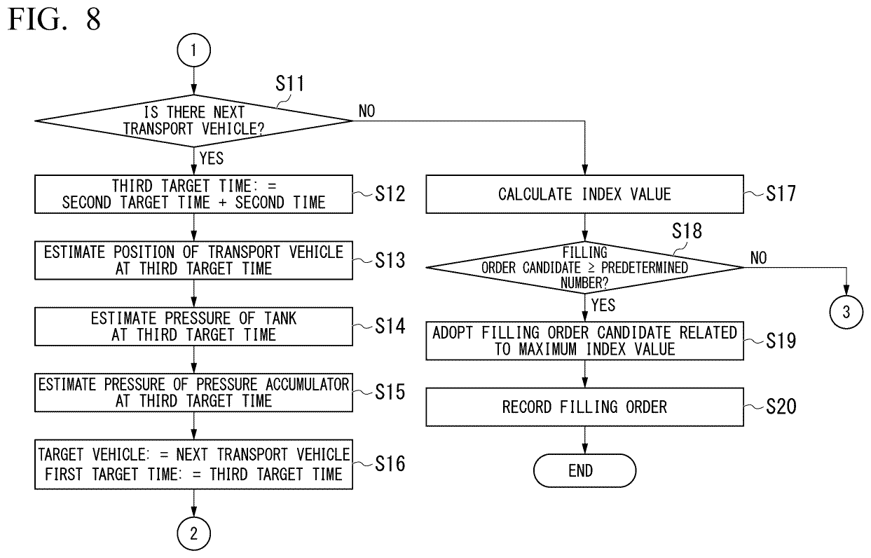

FIG. 7 is a flowchart (part 1) showing a hydrogen gas filling order determining method for the management device 50 according to the first embodiment. FIG. 8 is a flowchart (part 2) showing the hydrogen gas filling order determining method for the management device 50 according to the first embodiment. The management device 50 performs hydrogen gas filling order determining processing shown in FIG. 7, for example, each time filling of the plurality of transport vehicles 10 with a hydrogen gas is completed according to the filling order.

The management device 50 determines hydrogen gas filling order for the plurality of transport vehicles 10 according to the following procedures. First, the measured value acquisition unit 51 of the management device 50 receives measured values of a position, an azimuth direction, a speed, and a pressure of the hydrogen tank 141 from the plurality of transport vehicles 10 (Step S1). In addition, the measured value acquisition unit 51 receives a measured value of the pressure of the pressure accumulator P33 from the hydrogen station P3 (Step S2).

Next, the candidate generation unit 52 randomly determines a hydrogen gas filling order candidate of the plurality of transport vehicles 10 (Step S3). The estimation unit 53 determines the transport vehicle 10 which is first in the filling order candidate determined in Step S3 as a target vehicle and determines the current time as a first target time (Step S4). The target vehicle is the transport vehicle 10 to be filled with a hydrogen gas in an operation simulation of the transport vehicle 10. The first target time is a time that is a starting point of calculation in the operation simulation.

The estimation unit 53 estimates a first time that is a time for which the target vehicle reaches the hydrogen station P3 from a position at the first target time (Step S5). For example, the estimation unit 53 estimates the first time by multiplying a distance from a position of the target vehicle at a target time to the hydrogen station P3 by a speed limit of the transport vehicle 10, which is determined in the operation rules. The position of the target vehicle at the first target time in a case of initial calculation is a position indicated by the measured value received in Step S1. The position of the target vehicle at the first target time in a case of second and subsequent calculations is calculated in Step S12 to be described later.

Next, the estimation unit 53 determines a time obtained by adding the first time calculated in Step S5 to the first target time as a second target time (Step S6). The second target time is a time when the target vehicle reaches the hydrogen station P3, that is, a hydrogen gas filling start time for the target vehicle. The estimation unit 53 estimates the pressure of the hydrogen tank 141 of the target vehicle at the second target time (Step S7). For example, the estimation unit 53 estimates the pressure of the hydrogen tank 141 of the target vehicle at the second target time according to the following procedures. First, the estimation unit 53 identifies a decrease rate of the pressure of a hydrogen gas, which is determined in advance, for a section of the course C in which the transport vehicle 10 travels. The decrease rate of the pressure of the hydrogen gas for each section is calculated in advance based on a gradient, a speed limit, or the like of the section. Next, the estimation unit 53 acquires a decreased amount of the pressure obtained by multiplying the first time calculated in Step S5 by the identified decrease rate. The estimation unit 53 estimates the pressure of the hydrogen tank 141 of the target vehicle at the second target time by subtracting the acquired decreased amount from the pressure of the hydrogen tank 141 at the first target time. In addition, the estimation unit 53 estimates the pressure of the pressure accumulator P33 of the hydrogen station P3 at the second target time (Step S8). For example, the estimation unit 53 estimates the pressure of the pressure accumulator P33 at the second target time according to the following procedures. First, the estimation unit 53 acquires an increased amount of pressure by multiplying an increase rate of the pressure of the pressure accumulator P33 attributable to the compressor P32 by the first time calculated in Step S5. The estimation unit 53 estimates the pressure of the pressure accumulator P33 at the second target time by adding the acquired increased amount to the pressure of the pressure accumulator P33 at the first target time.

The estimation unit 53 estimates a differential pressure between the hydrogen tank 141 of the target vehicle and the pressure accumulator P33 at the second target time (Step S9). The estimation unit 53 estimates a second time that is a time required for completing filling of the hydrogen tank 141 of the target vehicle with the hydrogen gas based on the estimated differential pressure (Step S10). A relationship between the differential pressure between the hydrogen tank 141 and the pressure accumulator P33 and a change amount of the pressure of the hydrogen tank 141 per unit time can be calculated in advance. For this reason, the estimation unit 53 estimates a time for which a time integral value of a change amount of the pressure becomes equal to the difference between the pressure of the hydrogen tank 141 of the target vehicle at the second target time and the pressure of the hydrogen tank 141 at a time of full filling as the second time.

The estimation unit 53 determines whether or not there is the next transport vehicle 10 after the target vehicle in the filling order candidate determined in Step S3 (Step S11).

In a case where there is the next transport vehicle 10 (Step S11: YES), the estimation unit 53 determines a time obtained by adding the second time to the second target time as a third target time (Step S12). The estimation unit 53 estimates a position of the transport vehicle 10, other than the target vehicle, at the third target time (Step S13). For example, the estimation unit 53 estimates the position of the transport vehicle 10 at the third target time by adding a distance, which is obtained by multiplying the speed limit of the transport vehicle 10 determined in the operation rules by a sum of the first time and the second time, to the position of the transport vehicle 10 at the first target time. The position of the target vehicle at the third target time is the position of the hydrogen station P3. Next, the estimation unit 53 estimates a pressure of the hydrogen tank 141 of the transport vehicle 10, other than the target vehicle, at the third target time (Step S14). For example, the estimation unit 53 identifies the decrease rate of the pressure of the hydrogen gas, which is determined in advance, for the section of the course C in which the transport vehicle 10 travels. Next, the estimation unit estimates the pressure of the hydrogen tank 141 of the transport vehicle 10 at the third target time by subtracting a decreased amount of the pressure obtained by multiplying the identified decrease rate by the sum of the first time and the second time from the pressure of the hydrogen tank 141 at the first target time. In addition, the estimation unit 53 estimates the pressure of the pressure accumulator P33 of the hydrogen station P3 at the third target time (Step S15). For example, the estimation unit 53 estimates the pressure of the pressure accumulator P33 at the third target time by subtracting the change amount of the pressure of the hydrogen tank 141 for the second time from the pressure of the pressure accumulator P33 at the second target time. Then, the estimation unit 53 changes the target vehicle to the next transport vehicle 10 and changes the first target time to a value of the third target time (Step S16). Then, the estimation unit 53 returns the processing to Step S5.

In a case where there is no next transport vehicle 10 in Step S11 (Step S11: NO), the estimation unit 53 calculates a total of differential pressures between the hydrogen tank 141 of the plurality of transport vehicles 10 and the pressure accumulator P33 at times of hydrogen gas filling start, which are calculated in Step S9, as an index value of a hydrogen gas filling time (Step S17). The index value increases as the filling time decreases.

Through processing from Step S4 to Step S17, the management device 50 can estimate a filling start time of each of the plurality of transport vehicles 10 such that two or more transport vehicles 10 do not exist simultaneously at the hydrogen station P3.

The candidate generation unit 52 determines whether or not there are a predetermined number or more of generated filling order candidates (Step S18). In a case where there are less than the predetermined number of filling order candidates (Step S18: NO), the management device 50 returns the processing to Step S3 and calculates an index value for the next filling order candidate. On the other hand, in a case where there are the predetermined number or more of filling order candidates (Step S18: YES), the determination unit 54 determines a candidate having the largest index value calculated in Step S17, among the plurality of filling order candidates generated by the candidate generation unit 52, as filling order to be adopted (Step S19). The determination unit 54 records the determined filling order in the storage unit 55 (Step S20) and ends the filling order determining processing. Determination as to whether or not there is the predetermined number or more of filling order candidates in Step S18 may be made by the determination unit 54. In this case, when there are less than the predetermined number of filling order candidates, the determination unit 54 instructs the candidate generation unit 52 to generate a new filling order candidate.

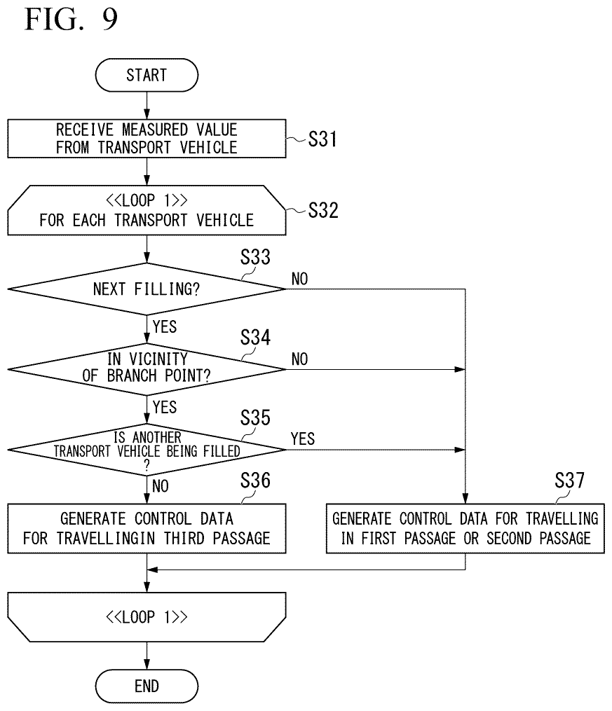

Accordingly, the management device 50 can control the transport vehicle 10 such that the transport vehicle 10 moves to the hydrogen station P3 according to the filling order stored in the storage unit 55. FIG. 9 is a flowchart showing a transmitting method of control data of the transport vehicle 10 for the management device 50 according to the first embodiment. The management device 50 executes transmission processing of control data shown in FIG. 8 for each fixed control cycle.

First, the measured value acquisition unit 51 of the management device 50 receives a position, an azimuth direction, and a speed from the plurality of transport vehicles 10 (Step S31). Next, the management device 50 selects the transport vehicle 10 one by one (Step S32) and performs calculation shown in the following Steps S33 to S37 for the selected transport vehicle 10.

The control data generation unit 56 determines whether or not the transport vehicle 10 to be filled with the hydrogen gas next is the transport vehicle 10 selected in Step S32 with reference to the filling order stored in the storage unit 55 (Step S33). In a case where the transport vehicle 10 to be filled with the hydrogen gas next is the transport vehicle 10 selected in Step S32 (Step S33: YES), it is determined that whether or not the selected transport vehicle 10 is positioned in the vicinity of a branch point of the third passage C3 based on the measured value of the position received in Step S31 (Step S34). The vicinity of the branch point may be in, for example, a range from a point ahead of the branch point by a distance traveled by the transport vehicle 10 for a time related to the control cycle to the branch point. In a case where the selected transport vehicle 10 is positioned in the vicinity of the branch point of the third passage C3 (Step S34: YES), it is determined that whether or not another transport vehicle 10 is being filled with the hydrogen gas at the hydrogen station P3 (Step S35). In a case where there is no other transport vehicle 10 being filled (Step S35: NO), the control data generation unit 56 generates control data for causing the selected transport vehicle 10 to travel in the third passage C3 (Step S36). On the other hand, in a case where the transport vehicle 10 to be filled with the hydrogen gas is not the transport vehicle 10 selected in Step S32 (Step S33: NO), a case where the selected transport vehicle 10 is not positioned in the vicinity of the branch point (Step S34: NO), or a case where another transport vehicle 10 is being filled with the hydrogen gas at the hydrogen station P3 (Step S35: YES), the control data generation unit 56 generates control data for causing the selected transport vehicle 10 to travel in the first passage C1 or the second passage C2 (Step S37).

### Workings and Effects

As described above, based on the measured value of the pressure of the hydrogen tank 141 of each of the plurality of transport vehicles 10 and the measured value of the pressure of the pressure accumulator P33 of the hydrogen station P3, the management device 50 according to the first embodiment determines filling timings of a hydrogen gas of the plurality of transport vehicles 10 such that the total of hydrogen gas filling times for the plurality of transport vehicles 10 at the hydrogen station is minimized. Accordingly, the management device 50 can determine an appropriate replenishment timing of the hydrogen gas for the management device 50 on which the fuel cell is mounted.

In addition, the management device 50 according to the first embodiment calculates an index value of a filling time based on a differential pressure between the hydrogen tank 141 and the pressure accumulator P33 at a time of hydrogen gas filling start. A filling speed of a hydrogen gas is determined by the differential pressure between the hydrogen tank 141 and the pressure accumulator P33. For this reason, the management device 50 can calculate the index value based on the differential pressure between the hydrogen tank 141 and the pressure accumulator P33 and determine an appropriate replenishment timing of the hydrogen gas by determining a filling timing such that the index value is maximized.

### Other Embodiment

Although one embodiment has been described in detail with reference to the drawings hereinbefore, a specific configuration is not limited to the description above, and various design changes are possible. That is, in the other embodiment, order of processing described above may be changed as appropriate. In addition, some of the processing may be performed in parallel.

The management device 50 according to the embodiment described above may be configured by a single computer, or the configuration of the management device 50 may be divided and disposed into a plurality of computers, and the plurality of computers may function as the management device 50 by cooperating with each other. At this time, some of the computers configuring the management device 50 may be provided at the hydrogen station P3.

The management device 50 according to the embodiment described above performs the hydrogen gas filling order determining processing each time filling of the plurality of transport vehicles 10 with a hydrogen gas is completed according to the filling order, but is not limited thereto. For example, the management device 50 according to the other embodiment may perform the filling order determining processing in response to other triggers, such as a time when there is a transport vehicle 10 in which the pressure of the hydrogen tank 141 falls below a predetermined value, among the plurality of transport vehicles 10.

The management device 50 according to the embodiment described above causes all the plurality of transport vehicles 10 to be filled with a hydrogen gas according to determined filling order, but is not limited thereto. For example, the management device 50 according to the other embodiment may determine filling order for the transport vehicle 10 in which the pressure of the hydrogen tank 141 falls below the predetermined value, among the plurality of transport vehicles 10, and may not perform calculation for the transport vehicle 10 in which the pressure of the hydrogen tank 141 is equal to or higher than the predetermined value.

The management device 50 according to the embodiment described above generates the predetermined number of filling order candidates and determines optimum filling order from those, but is not limited thereto. For example, the management device 50 according to the other embodiment may repeatedly generate filling order candidates from the start of filling of the transport vehicle 10 with a hydrogen gas to the end of the filling and determine the next filling order. In this case, the management device 50 may re-calculate filling order each time the transport vehicle 10 positioned first in the filling order reaches the hydrogen station P3. Estimation accuracy of the position of the transport vehicle 10, the pressure of the hydrogen tank 141, and the pressure of the pressure accumulator P33 of the hydrogen station P3 decreases as the time becomes further from the current time. For this reason, as the filling order is re-calculated each time the transport vehicle 10 reaches the hydrogen station P3, appropriate filling order can be continued to be calculated at all times.

The management device 50 according to the embodiment described above determines filling order of the transport vehicle 10, but is not limited thereto. For example, the management device 50 according to the other embodiment may determine a filling start time of each transport vehicle 10, that is, a filling timing. In this case, the candidate generation unit 52 randomly determines a filling timing of each of the plurality of transport vehicles 10 and estimates a filling time at the filling timing for each transport vehicle 10.

In addition, the management device 50 according to the other embodiment may determine filling order in the same procedures as in the first embodiment and determine a filling start time of each transport vehicle 10 estimated by the estimation unit 53 as a filling timing.

The management device 50 according to the embodiment described above randomly generates a filling order candidate, but is not limited thereto. For example, the management device 50 according to the other embodiment may generate a filling order candidate based on a weight according to the pressure of the hydrogen tank 141. That is, the management device 50 according to the other embodiment may generate a filling order candidate such that the transport vehicle 10 in which the pressure of the hydrogen tank 141 is low is preferentially selected.

At the hydrogen station P3 according to the embodiment described above, only one transport vehicle 10 can be filled with a hydrogen gas simultaneously, but is not limited thereto. For example, in the other embodiment, two or more transport vehicles 10 may be simultaneously filled with the hydrogen gas at the hydrogen station P3. In this case, the management device 50 estimates a filling start time of each of the plurality of transport vehicles 10 such that the transport vehicles 10 exceeding a simultaneously fillable number do not exist at the hydrogen station P3.

### Computer Configuration

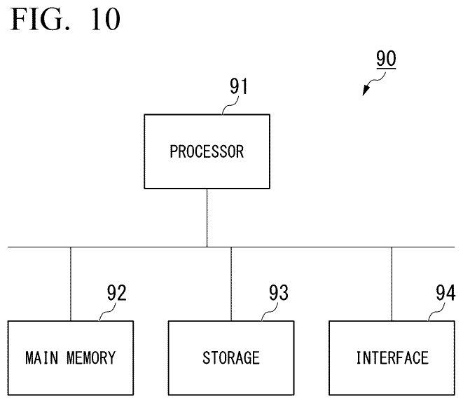

FIG. 10 is a schematic block diagram showing a configuration of the computer according to at least one embodiment.

A computer 90 includes a processor 91, a main memory 92, a storage 93, and an interface 94.

The management device 50 described above is mounted on the computer 90. In addition, an operation of each processing unit described above is stored in the storage 93 in a form of a program. The processor 91 reads out the program from the storage 93, develops the program on the main memory 92, and executes the processing according to the program. In addition, the processor 91 secures a storage region corresponding to each storage unit described above in the main memory 92 according to the program. Examples of the processor 91 include a CPU, a GPU, and a microprocessor.

The program may be used to implement some of the functions of the computer 90. For example, the program may implement the functions in combination with other programs already stored in the storage or in combination with other programs installed in other devices. In the other embodiment, the computer 90 may include a custom LSI such as a PLD in addition to the configuration or instead of the configuration. Examples of the PLD include a PAL, a GAL, a CPLD, and an FPGA. In this case, some or all of the functions realized by the processor 91 may be realized by the integrated circuit. Such an integrated circuit is also included as an example of the processor.

Examples of the storage 93 include a magnetic disk, a magneto-optical disk, an optical disk, and a semiconductor memory, or the like. The storage 93 may be an internal medium that is directly connected to a bus of the computer 90 or may be an external medium that is connected to the computer 90 via the interface 94 or a communication line. In addition, in a case where the program is distributed to the computer 90 via the communication line, the computer 90 that has received the distribution may develop the program on the main memory 92 and execute the processing. In at least one embodiment, the storage 93 is a non-transitory tangible storage medium.

In addition, the program may be for realizing some of the functions described above. Further, the program may be a so-called differential file (differential program) that realizes the functions described above in combination with other programs already stored in the storage 93.

### Industrial Applicability

Filling timings of a hydrogen gas of a plurality of work vehicles on which hydrogen tanks are mounted can be determined.

### Reference Signs List

1: Automatic transport system
10: Transport vehicle
11: Dump body
12: Vehicle body
13: Traveling device
14: Power system
141: Hydrogen tank
142: Hydrogen supply device
143: Fuel cell
144: Battery
145: DCDC converter
15: Drive system
151 : Inverter
152: Pump drive motor
153: Hydraulic pump
154: Hoist cylinder
155: Inverter
156: Travelling drive motor
16: Control system
161: Measurement device
162: Communication device
163: Control device
50: Management device
51: Measured value acquisition unit
52: Candidate generation unit
53: Estimation unit
54: Determination unit
55: Storage unit
56: Control data generation unit
57: Control data transmission unit
90: Computer
91: Processor
92: Main memory
93: Storage
94: Interface
B: Bus
C: Course
C1: First passage
C2: Second passage
C3: Third passage
P1: Mining site
P2: Dumping site
P3: Hydrogen station
P31: Hydrogen storage
P32: Compressor
P33: Pressure accumulator
P34: Dispenser
P35: Pressure gauge
P36: Communication device

1. A work vehicle management device comprising:
a measured value acquisition unit configured to acquire a measured value of a pressure of a hydrogen tank of each of a plurality of work vehicles, on which the hydrogen tanks are mounted, and a measured value of a pressure of a pressure accumulator of a hydrogen station where the hydrogen tanks are filled with a hydrogen gas; and
a determination unit configured to determine filling timings or filling order of the hydrogen gas for the plurality of work vehicles based on the measured values of the pressures.

2. The work vehicle management device according to claim 1, further comprising:
an estimation unit configured to estimate a value related to a filling time of the hydrogen gas at the hydrogen station for the plurality of work vehicles based on the measured values of the pressures,
wherein the determination unit determines the filling timings or the filling order of the hydrogen gas for the plurality of work vehicles based on the value related to the filling time.

3. The work vehicle management device according to claim 2,
wherein the determination unit determines the filling timings or the filling order of the hydrogen gas for the plurality of work vehicles such that a total of the filling times is minimized based on the value related to the filling time.

4. The work vehicle management device according to claim 3,
wherein the value related to the filling time is a differential pressure between the pressure of the hydrogen tank and the pressure of the pressure accumulator at a time of hydrogen gas filling start, and
the determination unit determines the filling timing or the filling order such that a total of the differential pressures between the pressure of the hydrogen tank and the pressure of the pressure accumulator at the time of hydrogen gas filling start of each of the plurality of work vehicles is maximized.

5. The work vehicle management device according to claim 3, further comprising:
a candidate generation unit configured to generate a plurality of candidates related to the filling timings or the filling order of the hydrogen gas for the plurality of work vehicles,
wherein the estimation unit estimates the value related to the filling time of the hydrogen gas for each of the plurality of candidates, and
the determination unit determines the filling timings or the filling order of the hydrogen gas for the plurality of work vehicles based on a candidate in which a total of the filling times is minimized, among the plurality of candidates.

6. The work vehicle management device according to claim 5,
wherein the candidate generation unit generates a candidate of the filling order of the hydrogen gas, and
the estimation unit
estimates a time when filling of each of the plurality of work vehicles with the hydrogen gas starts at the hydrogen station such that work vehicles exceeding a simultaneously fillable number do not exist simultaneously at the hydrogen station according to the filling order,
estimates a differential pressure between the hydrogen tank and the pressure accumulator at the estimated time based on the measured values of the pressures, and
estimates the filling time of the hydrogen gas based on the differential pressure.

7. The work vehicle management device according to claim 1, further comprising:
a control data generation unit configured to generate control data of the plurality of work vehicles based on the filling timing or the filling order determined by the determination unit; and
a control data transmission unit configured to transmit the control data to the plurality of work vehicles.

8. A system comprising:
a plurality of work vehicles including a hydrogen tank, a pressure gauge that acquires a measured value of a pressure of the hydrogen tank, and a communication device that transmits the measured value of the pressure of the hydrogen tank;
a hydrogen station including a pressure accumulator that raises a pressure of a hydrogen gas to a predetermined pressure to be filled with the hydrogen gas, a pressure gauge that acquires a measured value of a pressure of the pressure accumulator, and a communication device that transmits the measured value of the pressure of the pressure accumulator; and
a management device including a communication device that receives the measured value of the pressure of the hydrogen tank and the measured value of the pressure of the pressure accumulator and a determination unit that determines filling timings or filling order of the hydrogen gas for the plurality of work vehicles based on the measured value of each of the pressure of the hydrogen tank and the pressure of the pressure accumulator.

9. The system according to claim 8,
wherein the management device includes an estimation unit that estimates a value related to a filling time of the hydrogen gas at the hydrogen station for the plurality of work vehicles based on the measured values of the pressures, and
the determination unit determines the filling timings or the filling order of the hydrogen gas for the plurality of work vehicles based on the value related to the filling time.

10. The system according to claim 9,
wherein the determination unit determines the filling timings or the filling order of the hydrogen gas for the plurality of work vehicles such that a total of the filling times is minimized based on the value related to the filling time.

11. The system according to claim 10,
wherein the value related to the filling time is a differential pressure between the pressure of the hydrogen tank and the pressure of the pressure accumulator at a time of hydrogen gas filling start, and
the determination unit determines the filling timing or the filling order such that a total of the differential pressures between the pressure of the hydrogen tank and the pressure of the pressure accumulator at the time of hydrogen gas filling start of each of the plurality of work vehicles is maximized.

12. The system according to claim 10,
wherein the management device includes a candidate generation unit that generates a plurality of candidates related to the filling timings or the filling order of the hydrogen gas for the plurality of work vehicles,
the estimation unit estimates the value related to the filling time of the hydrogen gas for each of the plurality of candidates, and
the determination unit determines the filling timings or the filling order of the hydrogen gas for the plurality of work vehicles based on a candidate in which a total of the filling times is minimized, among the plurality of candidates.

13. The system according to claim 12,
wherein the candidate generation unit generates a candidate of the filling order of the hydrogen gas, and
the estimation unit
estimates a time when filling of each of the plurality of work vehicles with the hydrogen gas starts at the hydrogen station such that work vehicles exceeding a simultaneously fillable number do not exist simultaneously at the hydrogen station according to the filling order,
estimates a differential pressure between the hydrogen tank and the pressure accumulator at the estimated time based on the measured values of the pressures, and
estimates the filling time of the hydrogen gas based on the differential pressure.

14. The system according to claim 8, further comprising:
a control data generation unit configured to generate control data of the plurality of work vehicles based on the filling timing or the filling order determined by the determination unit; and
a control data transmission unit configured to transmit the control data to the plurality of work vehicles.

15. A work vehicle management method comprising:
a step of acquiring a measured value of a pressure of a hydrogen tank of each of a plurality of work vehicles, on which the hydrogen tanks are mounted, and a measured value of a pressure of a pressure accumulator of a hydrogen station where the hydrogen tanks are filled with a hydrogen gas; and
a step of determining filling timings or filling order of the hydrogen gas for the plurality of work vehicles based on the measured values of the pressures.

16. The work vehicle management method according to claim 15, further comprising:
a step of estimating a value related to a filling time of the hydrogen gas at the hydrogen station for the plurality of work vehicles based on the measured values of the pressures,
wherein in the step of determining the filling timings or the filling order, the filling timings or the filling order of the hydrogen gas for the plurality of work vehicles is determined based on the value related to the filling time.

17. The work vehicle management method according to claim 16,
wherein in the step of determining the filling timings or the filling order, the filling timings or the filling order of the hydrogen gas for the plurality of work vehicles is determined such that a total of the filling times is minimized based on the value related to the filling time.

18. The work vehicle management method according to claim 17,
wherein the value related to the filling time is a differential pressure between the pressure of the hydrogen tank and the pressure of the pressure accumulator at a time of hydrogen gas filling start, and
in the step of determining the filling timing or the filling order, the filling timing or the filling order is determined such that a total of the differential pressures between the pressure of the hydrogen tank and the pressure of the pressure accumulator at the time of hydrogen gas filling start of each of the plurality of work vehicles is maximized.

19. The work vehicle management method according to claim 17, further comprising:
a step of generating a plurality of candidates related to the filling timings or the filling order of the hydrogen gas for the plurality of work vehicles,
wherein in the step of estimating the value related to the filling time, the value related to the filling time of the hydrogen gas for each of the plurality of candidates is estimated, and
in the step of determining the filling timings or the filling order, the filling timings or the filling order of the hydrogen gas for the plurality of work vehicles is determined based on a candidate in which a total of the filling times is minimized, among the plurality of candidates.

20. The work vehicle management method according to claim 19,
wherein in the step of generating the plurality of candidates, a plurality of candidates related to the filling order of the hydrogen gas are generated, and
in the step of estimating the value related to the filling time,
a time when filling of each of the plurality of work vehicles with the hydrogen gas starts at the hydrogen station is estimated such that work vehicles exceeding a simultaneously fillable number do not exist simultaneously at the hydrogen station according to the filling order,
a differential pressure between the hydrogen tank and the pressure accumulator at the estimated time is estimated based on the measured values of the pressures, and
the filling time of the hydrogen gas is estimated based on the differential pressure.
